(19) United States
(12) Patent Application Publication
(10) Pub. No.: US 2014/0139538 A1
(43) Pub. Date: May 22, 2014

(54) METHOD AND APPARATUS FOR OPTIMIZING IMAGE QUALITY BASED ON MEASUREMENT OF IMAGE PROCESSING ARTIFACTS

(71) Applicant: DATACOLOR HOLDING AG, Luzern (CH)

(72) Inventors: HEATH BARBER, Fuquay Varina, NC (US); Joshua Kairoff, Long Beach, CA (US)

(73) Assignee: Datacolor Holding AG, Luzern (CH)

(21) Appl. No.: 13/680,589

(22) Filed: Nov. 19, 2012

(51) Int. Cl. G09G 5/00

(52) U.S. Cl. CPC G09G 5/00
USPC 345/581

(57) ABSTRACT

Adjusting a spatial and/or temporal attribute of an image display device includes measuring a visual change on a display of the image display device, wherein the visual change is caused by an image processing artifact that is introduced or removed, inferring a correlated effect of the attribute on the display, based on the measuring, and generating an adjustment that adjusts the attribute to a setting that is selected based on the effect. Another method for adjusting an attribute of an image display device includes measuring a light volume emitted by a display of the image display device at a plurality of settings of the attribute, identifying one of the plurality of settings at which a greatest change in the light volume is produced with a smallest change in the attribute, and outputting an instruction to set the attribute to the one of the plurality of settings.

### FIELD OF THE INVENTION

The present invention generally relates to the measurement of light, and more specifically relates to the use of light measurement for optimization of images produced on display devices.

### BACKGROUND

The quality of an image displayed on an image display device is the result of a combination of settings of image processing and/or filtering attributes (e.g., sharpness, brightness, contrast, etc.). Measuring these attributes and identifying their optimal settings can be difficult, particularly for the average user of an image display device. Often, adjusting the settings is a matter of trial and error with little or no quantifiable guidance. As such, many image display devices process and filter images in accordance with settings that are less than optimal.

Although tools exist for assisting users in setting these attributes, such tools need to be able to accurately measure visual changes caused by the image processing and filtering technologies in order to be effective. In addition, the visual (visible) changes in an image must, in general, be assessed at the pixel level by an imaging device (e.g., a camera). However, no known tools are capable of measuring a single quantity of light from a multi-pixel image area and using the measurement of that quantity to guide the user in setting an attribute of the display.

### SUMMARY OF THE INVENTION

Embodiments of the invention use measurements of light volume (i.e., a measure of the quantity of light entering a detector) to generate adjustments to settings of image display devices. An example of the light volume that is measured may be, for example, luminance. In particular, a light measurement device (e.g., a light meter) takes a single measurement of the light volume of a constant plurality of pixels. This measurement guides the adjustment of a spatial attribute (e.g., sharpness) of the image display device to an optimal value. Conventionally, this optimal value is otherwise inferable only from an imaging device that measures light from individual pixels and subsequently performs image analysis on the measurements of these individual pixels.

A method for accurately and objectively adjusting a spatial and/or temporal attribute of an image display device includes measuring a visual change on a display of the image display device, wherein the visual change is caused by an image processing artifact that is introduced or removed, inferring a correlated effect of the spatial attribute on the display, based on the measuring, and generating an adjustment that adjusts the spatial attribute to a setting that is selected in accordance with the effect.

In another embodiment, a method for adjusting a spatial and/or temporal attribute of an image display device includes measuring a light volume emitted by a display of the image display device at a plurality of settings of the spatial attribute, identifying one of the plurality of settings at which a greatest change in the light volume is produced with a smallest change in the spatial attribute, and outputting an instruction to set the spatial attribute to the one of the plurality of settings.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a system for optimizing the displayed image quality of an image display device, according to the present invention;

FIG. 2 is a flow diagram illustrating one embodiment of a method for optimizing image quality on an image display device, according to the present invention;

FIG. 3 illustrates an exemplary monochromatic test pattern suitable for measuring the sharpness settings of a typical image display device;

FIGS. 4A-4B illustrate the test pattern of FIG. 3 as displayed at the lowest and highest sharpness settings, respectively, of an exemplary image display device; and

FIG. 5 is a high-level block diagram of the display optimization method that is implemented using a general purpose computing device.

### DETAILED DESCRIPTION

In one embodiment, the present invention is a method and apparatus for optimizing image quality on an image display device based on measurement of image processing artifacts. Embodiments of the invention exploit common but typically ignored characteristics of displayed image artifacts in order to optimize the quality of an image displayed on an image display device. In particular, spatial and/or temporal attributes of the display device's image processing and filtering functions (e.g., image sharpness, brightness, contrast, etc.) can be deduced based on quantifiable changes in the amount of light energy (e.g., photons) produced on the display device due to the presence of image processing artifacts. These deductions can then be used to adjust the spatial attributes as appropriate in order to optimize the display characteristics.

Within the context of the present invention, an “artifact” or “image artifact” refers to a visible spatial or spatio-chromatic anomaly that appears during visual representation of an image. The artifact may be the result of a malfunction or misuse of hardware or software, or simply a technical limitation of the hardware or software. For instance, the artifact might be introduced as a result of analog or digital image processing, encoding, transcoding, filtering, frame rate conversion, backlight adjustment, backlight zone dimming, ambient light level compensation, ambient light spectra compensation, or the like. The artifact may manifest itself as, for example, an image quality factor (e.g., an anomaly in sharpness, noise, dynamic range, tone reproduction, contrast, color accuracy, distortion, vignetting, exposure accuracy, lateral chromatic aberration, lens flare, or color moiré), a digital artifact resulting from digital image processing (e.g., data compression and transmission loss, oversharpening “halo,” loss of fine, low-contrast detail, texture corruption, T-vertex, pixilation, aliasing, or line scanning), screen door effect or fixed pattern noise, silk screen effect, rainbow effect, screen tearing, purple fringing, or the like.

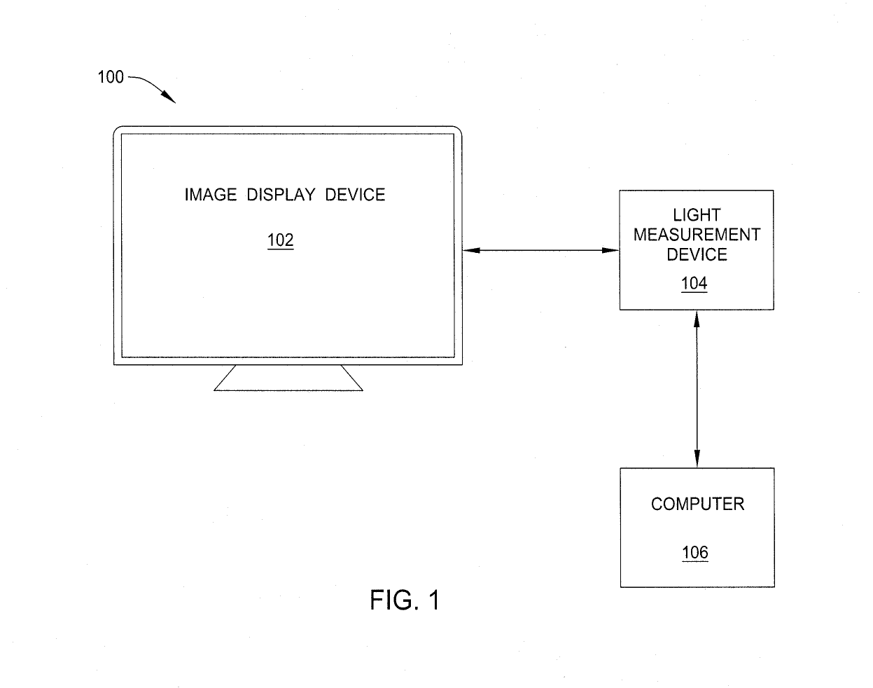

FIG. 1 is a schematic diagram illustrating one embodiment of a system 100 for optimizing the displayed image quality of an image display device 102, according to the present invention. As illustrated, the system 100 generally comprises an image display device 102, a light measurement device 104, and a computer 106.

The image display device 102 comprises any type of electronic device that is used to display still and/or video images. Thus, the image display device may comprise, for example, a television, a computer monitor, or even a mobile device such as a laptop computer, a tablet computer, a portable gaming device, a portable navigation system, or a mobile phone. The image display device 102 may further comprise circuitry for performing image processing and filtering prior to display.

The light measurement device 104 comprises a device that measures the amount of light emitted by an object (in the case of FIG. 1, the amount of light energy emitted by a multi-pixel region of the image display device 102). Thus, the light measurement device 104 may comprise, for example, a single-channel device (e.g., a light meter) or a multi-channel device (e.g., a colorimeter or spectroradiometer). In one embodiment, the light measurement device 104 is separate from (i.e., not integrated with) the image display device 102.

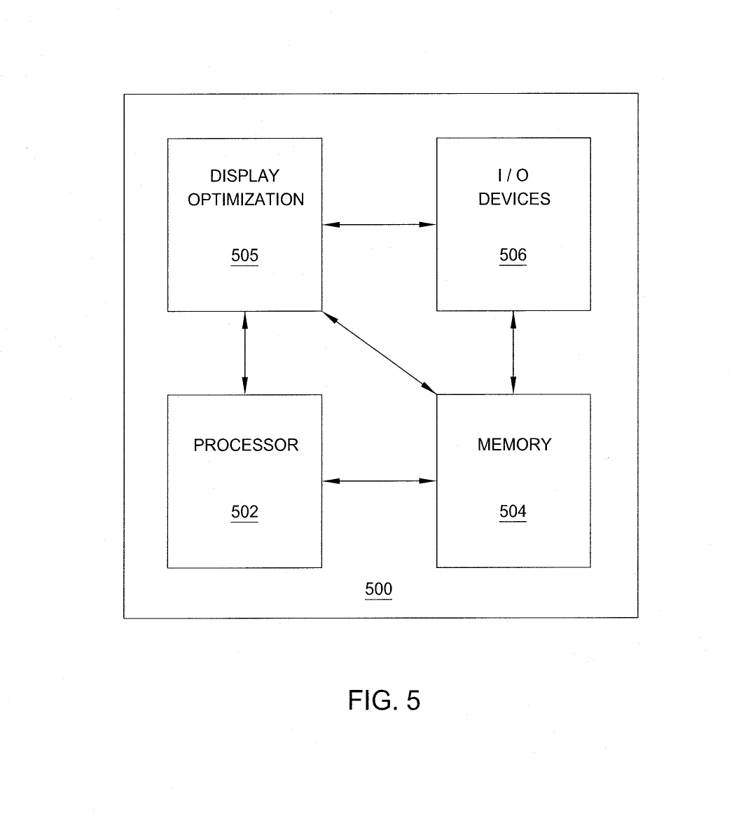

The computer 106 is a computing device that is coupled to the light measurement device 104. In one embodiment, the computer 106 is integrated with the light measurement device 104 as a single unit; however, in other embodiments, the computer 106 and the light measurement device 104 are separate units. The computer 106 includes a processor that processes measurements taken by the light measurement device 104 and produces instructions for adjusting the image processing and/or image filtering settings of the image display device 102, as described in further detail below. One particular embodiment of the computer 106 is discussed in greater detail in connection with FIG. 5.

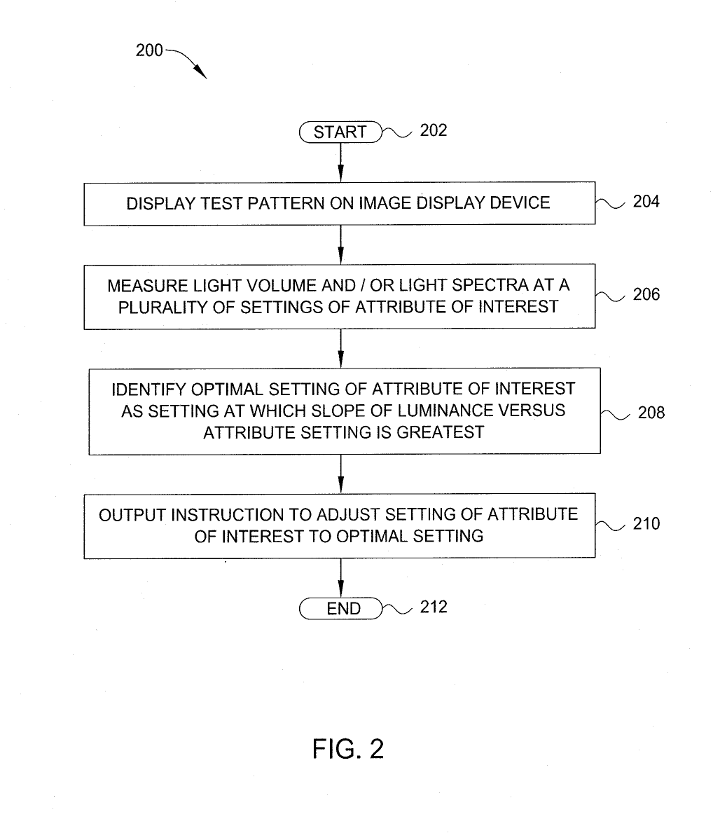

FIG. 2 is a flow diagram illustrating one embodiment of a method 200 for optimizing image quality on an image display device, according to the present invention. In particular, the method 200 measures and adjusts the setting of a particular attribute of an image display device (e.g., sharpness, brightness, contrast, etc.). The method 200 may be implemented for example, by the system 100 illustrated in FIG. 1. As such, reference is made in the discussion of the method 200 to various elements of the system 100. However, it will be appreciated that the method 200 is not limited by the configuration of the system 100, which is referenced for the purposes of example.

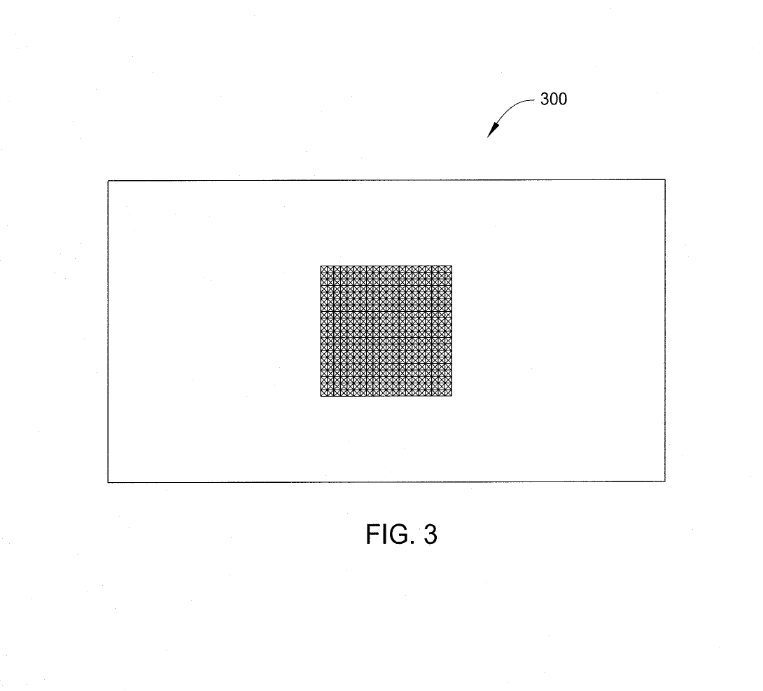

The method 200 begins in step 202. In step 204, the image display device 102 displays a test pattern. In one embodiment, the test pattern is a pattern that is stored in the image display device. In another embodiment, the test pattern is a pattern that is provided to the image display device 102 by an external device (e.g., the computer 106). In one embodiment, the test pattern is designed to produce measurable visible artifacts. For instance, the test pattern may include a plurality of edges. Depending on what image processing and filtering function is to be measured (e.g., sharpness, brightness, contrast, etc.), the test pattern may be monochromatic or polychromatic. For instance, a monochromatic test pattern may be sufficient to measure the general sharpness settings of the image display device 100, but a polychromatic test pattern may be desirable if a different attribute (e.g., the selection or optimization of red, green, and blue sharpness filter algorithms) is to be measured. FIG. 3, for example, illustrates an exemplary monochromatic test pattern 300 suitable for measuring the sharpness settings of a typical image display device 100. The test pattern 300 is suitable in this case because it has a high concentration of edges that are sensitive to the setting of the sharpness control.

In step 206, the light measurement device 104 measures the light volume (e.g., volume of light power and/or light spectra) emitted by the image display device 102 at a plurality of settings of the attribute of interest (e.g., sharpness, brightness, contrast, etc.). Within the context of the present invention, “light volume” is understood to refer to the total flux of photons captured by a light measurement device from an image display device that is driven by a test pattern. An example of light volume is luminance. The attribute of interest may be adjusted to each of the plurality of settings manually (e.g., by a human user) or automatically (e.g., by a program executing in the image display device 102 or by the image display device 102 under the direction of the computer 106). In one embodiment, step 204 involves measuring the light volume at each of the available settings of the attribute of interest; however, in other embodiments, the light volume may be measured at only a subset of the available settings of the attribute of interest. Measuring the light volume at less than all of the available settings may save processing time; however, the resultant display image quality may be slightly less than optimal.

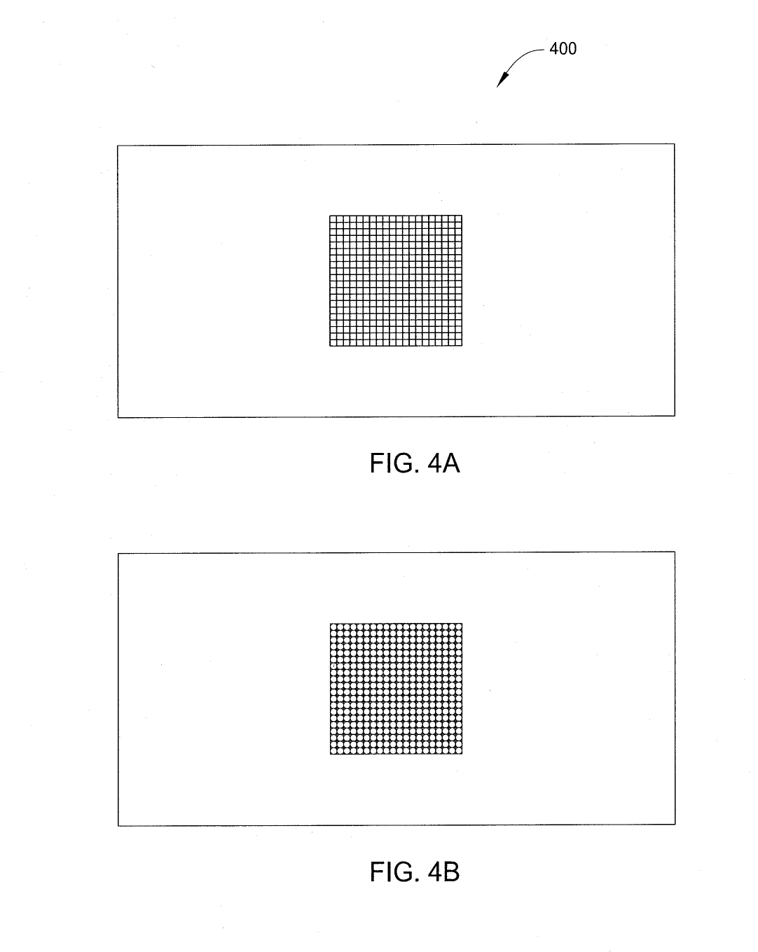

For instance, FIGS. 4A-4B illustrate the test pattern 300 of FIG. 3 as displayed at the lowest and highest sharpness settings, respectively, of an exemplary image display device. As illustrated, the change in displayed image artifacts changes (i.e., increases in the illustrated example) the ratio of dark image areas to bright image areas. As the light measurement device 104 measures a constant and fixed area of the image display, this changing ratio will produce a change in the effective volume of light power per measured area. These changes in light volume can be positively correlated to the image display device's image processing and/or filtering settings (which can in turn be used to produce measurements of the displayed effect of these settings, as described in greater detail below). In one embodiment, as little as one measurement of the image display at each setting of the attribute of interest is required. The light measurement device 104 delivers the measurements to the computer 106 for further processing.

In step 208, the computer 106 identifies the optimal setting, S_{b}, of the attribute of interest for which the slope of light volume (e.g., luminance) versus attribute setting (e.g., sharpness) is as great as possible. Mathematically, this can be expressed as finding the S_{b} for which:

|C(S+1)−C(S)| (EQN. 1)

is maximum, where S represents the attribute of interest and C(S) is the luminance of the image display device 102 as a function of the attribute of interest (e.g., in candelas per square meter). In other words, step 208 seeks to identify the setting that produces the greatest change in the light volume (as measured by the light measurement device 104) with the smallest change in the attribute of interest's setting. To avoid data artifacts, it may be necessary to disqualify for S_{b} values of S for which |C (S+1)−C(S)| is greater than a threshold (e.g., ten cd/m² in the case where C is luminance).

In step 210, the computer 106 outputs an instruction to adjust the setting of the attribute of interest to the optimal setting S_{b}. In one embodiment, the instruction is output directly to the image display device 102, so that the image display device 102 can automatically adjust the setting to the optimal setting. In another embodiment, the instruction is output for review by a human user, so that the human user can then manually adjust the setting to the optimal setting. In the latter case, the instruction may be displayed on the computer 106, on the image display device 102, or on another device.

The method 200 ends in step 212.

The method 200 therefore uses the quantifiable and measurable change in light volume or light spectra to infer the visual effects of display image processing and filtering technologies. In turn, this inference facilitates the identification of an optimal setting for a display attribute, such as sharpness. In an alternative embodiment, the same effects could be inferred from measurements of change in the frame rate rather than change in light volume.

FIG. 5 is a high-level block diagram of the display optimization method that is implemented using a general purpose computing device 500. As discussed above, the general purpose computing device 500 may comprise a portion of the computer 106 illustrated in FIG. 1. In one embodiment, a general purpose computing device 500 comprises a processor 502, a memory 504, a display optimization module 505 and various input/output (I/O) devices 506 such as a display, a keyboard, a mouse, a stylus, a wireless network access card, an Ethernet interface, a light meter, a colorimeter, a spectroradiometer, and the like. In one embodiment, at least one I/O device is a storage device (e.g., a disk drive, an optical disk drive, a floppy disk drive). It should be understood that the display optimization module 505 can be implemented as a physical device or subsystem that is coupled to a processor through a communication channel.

Alternatively, the display optimization module 505 can be represented by one or more software applications (or even a combination of software and hardware, e.g., using Application Specific Integrated Circuits (ASIC)), where the software is loaded from a storage medium (e.g., I/O devices 506) and operated by the processor 502 in the memory 504 of the general purpose computing device 500. Thus, in one embodiment, the display optimization module 505 for optimizing image quality on an image display device based on measurement of image processing artifacts, as described herein with reference to the preceding figures, can be stored on a tangible or physical computer readable storage medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying figures that recite a determining operation or involve a decision, do not necessarily require that both branches of the determining operation be practiced. In other words, one of the branches of the determining operation can be deemed as an optional step.

While the foregoing is directed to embodiments of the present invention, other and further embodiments of the invention may be devised without departing from the basic scope thereof. Various embodiments presented herein, or portions thereof, may be combined to create further embodiments. Furthermore, terms such as top, side, bottom, front, back, and the like are relative or positional terms and are used with respect to the exemplary embodiments illustrated in the figures, and as such these terms may be interchangeable.

What is claimed is:

1. A method for adjusting an attribute of an image display device, wherein the attribute is at least one of a spatial attribute or a temporal attribute, the method comprising:
detecting a visual change on a display of the image display device, wherein the visual change is caused by an image processing artifact that is introduced or removed; and
inferring a correlated effect of the attribute on the display, based on the visual change; and
generating an adjustment that adjusts the attribute to a setting that is selected in accordance with the effect.

2. The method of claim 1, wherein the visual change is a light volume emitted by the display.

3. The method of claim 2, wherein the light volume is a total flux of photons measured from the display while displaying the image processing artifact.

4. The method of claim 2, wherein the detecting comprises:
measuring the light volume emitted by the display while displaying a test pattern, wherein the test pattern includes the image processing artifact, and wherein the measuring is performed at a plurality of settings of the attribute.

5. The method of claim 4, wherein the attribute is a sharpness of the display.

6. The method of claim 5, wherein the inferring comprises:
identifying one of the plurality of settings at which a greatest change in the light volume is produced with a smallest change in the attribute.

7. The method of claim 4, wherein the test pattern is a monochromatic test pattern.

8. The method of claim 4, wherein the test pattern is a polychromatic test pattern.

9. The method of claim 4, wherein the measuring is performed using a light measurement device that is separate from the image display device.

10. The method of claim 9, wherein the light measurement device is a single channel light measurement device.

11. The method of claim 9, wherein the light measurement device is a multi-channel light measurement device.

12. The method of claim 1, wherein the adjusting comprises:
outputting an instruction to set the attribute to the setting.

13. The method of claim 1, wherein the image processing artifact is a visible spatial anomaly the appears during representation of an image on the display.

14. The method of claim 1, wherein the image processing artifact is a visible spatio-chromatic anomaly that appears during representation of an image on the display.

15. The method of claim 1, wherein the attribute is an attribute of an image processing function of the image display device.

16. The method of claim 1, wherein the attribute is an attribute of an image filtering function of the image display device.

17. The method of claim 1, wherein the detecting is performed on an area of the display that remains constant throughout the detecting.

18. The method of claim 1, wherein the visual change is a change in a frame rate of the display.

19. A system for adjusting an attribute of an image display device, wherein the attribute is at least one of a spatial attribute or a temporal attribute, the system comprising:
a processor; and
a computer readable medium containing an executable program that causes the processor to perform operations comprising:
detecting a visual change on a display of the image display device, wherein the visual change is caused by an image processing artifact that is introduced or removed; and
inferring a correlated effect of the attribute on the display, based on the visual change; and
generating an adjustment that adjusts the attribute to a setting that is selected in accordance with the effect.

20. A method for adjusting an attribute of an image display device, wherein the attribute is at least one of a spatial attribute or a temporal attribute, the method comprising:
measuring a light volume emitted by a display of the image display device at a plurality of settings of the attribute; and
identifying one of the plurality of settings at which a greatest change in the light volume is produced with a smallest change in the attribute; and
outputting an instruction to set the attribute to the one of the plurality of settings.
